(19) United States
(12) Patent Application Publication
(10) Pub. No.: US 2018/0009125 A1
(43) Pub. Date: Jan. 11, 2018

(54) PROCESS FOR PRODUCING RESINOUS PANEL

(71) Applicant: RIKEN TECHNOS CORPORATION, Tokyo (JP)

(72) Inventor: Satoshi SHIOTA, Tokyo (JP)

(73) Assignee: RIKEN TECHNOS CORPORATION, Tokyo (JP)

(21) Appl. No.: 15/546,573

(22) PCT Filed: Jan. 25, 2016
(86) PCT No.: PCT/JP2016/051998

§ 371 Date: Jul. 26, 2017

(30) Foreign Application Priority Data
Jan. 26, 2015 (JP) 2015-011905

(51) Int. Cl. B26F 1/44; B32B 27/36; B26F 1/40; B32B 27/08; B44F 9/04; B44C 5/04

(52) U.S. Cl. CPC B26F 1/44; B26F 1/40; B32B 27/08; B32B 27/36; B32B 2307/702; B32B 2307/402; B26F 2001/4472; B32B 2307/704; B44C 5/04; B44F 9/04; B32B 2307/412

(57) ABSTRACT

A process for producing a resinous panel which is for use as at least some of the front panel of an article, the process including (A) a step in which a resin sheet having a thickness of 0.5-10 mm is fixed to a working table and (B) a step in which the resin sheet is punched out by forcing a Thomson blade into the resin sheet approximately perpendicularly thereto from the side where the surface of the resin sheet is to be the outer surface of the article, thereby obtaining the front panel, wherein (C) the Thomson blade is a double-edged blade having an edge angle of 30-60 degrees. The resin sheet has a tensile modulus of preferably 1,500 MPa or greater. Preferably, the resin sheet includes a transparent resin sheet layer and a colored resin sheet layer in this order from the surface that is to be the outer surface of the article. The colored resin sheet is one which does not break when a DuPont impact test was conducted in accordance with ASTM-D2794 in a 0° C. environment under the conditions of a height of 50 cm, an impactor diameter of 1 inch, an impactor weight of 1 Kg, and a pedestal diameter of ½ inch.

### CROSS REFERENCE TO RELATED APPLICATIONS

This application claims the benefit of and priority to PCT/JP2016/051998, filed on Jan. 25, 2016, entitled (translation), “PROCESS FOR PRODUCING RESINOUS PANEL,” which claims the benefit of and priority to Japanese Patent Application No. 2015-011905, filed on Jan. 26, 2015, each of which is hereby incorporated by reference in their entirety into this application.

### BACKGROUND

### Field

Embodiments relate to a process for producing a resinous panel. More specifically, embodiments relate to a process for producing a resinous panel which can suitably be used, for example, in a front panel of a door body for opening/closing a front portion of a main body of an article such as a refrigerator, a washing machine, a cupboard, and a wardrobe, as well as in a flat panel of a lid body for opening/closing a flat portion of the main body.

### Description of Related Art

Conventionally, as a member constituting a front panel of a door body for opening/closing a front portion of a main body of an article such as a refrigerator, a washing machine, a cupboard, and a wardrobe, a steel plate has been used, since a sufficient strength and rigidity are required (For example, JP 2003-83671 A). However, use of a steel plate as a member constituting a front panel causes an inconvenience that a door body becomes heavy, since a steel plate has a large specific gravity. In addition, for having a high thermal conductivity, a steel plate has such a disadvantage that, for example in a case of a door body of a refrigerator, it is necessary to make a foam thick in order to obtain a sufficient heat insulating property, which requires a large space.

In recent years, glass has been attracting attention as a member constituting a front panel of a door body of an article such as a refrigerator, a washing machine, a cupboard, and a wardrobe, for its design impression with an impression of transparency. However, glass has disadvantages such as being easy to break for having low impact resistance, having low processability, and being heavy for having large specific gravity.

JP S63-163768 A and JP 05-288458 A suggest using a panel made of a resin sheet, in a front panel of a door body for opening/closing a front portion of a main body of a refrigerator. However, these literatures do not have any description or suggestion for process for producing a front panel from a resin sheet.

### SUMMARY

A problem to be solved by various embodiments is to provide a process for producing a resinous panel which can suitably be used, for example, in a front panel of a door body for opening/closing a front portion of a main body of an article such as a refrigerator, a washing machine, a cupboard, and a wardrobe, as well as in a flat panel of a lid body for opening/closing a flat portion of the main body.

Embodiments solve the aforementioned problem by punching a specific resin sheet by a specific process.

According to at least one embodiment, there is provided a process for producing a resinous panel which is for use as at least a part of a front panel of an article, in which the process includes the steps of: (A) fixing a resin sheet with a thickness of 0.5-10 mm to a working table; and (B) punching out the front panel by forcing a Thomson blade into the resin sheet approximately perpendicularly thereto from a side where a surface of the resin sheet is to be an outer surface of the article, wherein (C) the Thomson blade is a double-edged blade with an edge angle of 30-60 degrees.

According to at least one embodiment, the resin sheet preferably has a tensile modulus of elasticity of 1,500 MPa or more.

According to at least one embodiment, the resin sheet includes a layer of a transparent resin sheet and a layer of a colored resin sheet in this order from the side to be an outer surface of an article; and the colored resin sheet is one which does not break when subjected to a DuPont impact test in conformity with ASTM-D2794, in an atmosphere of a temperature of 0° C., under a condition of a height of 50 cm, a diameter of an impactor of 1 inch, a weight of an impactor of 1 kg, and a diameter of an impactor receiving support of ½ inch.

According to at least one embodiment, the resin sheet meets the following properties (i)-(iii): (i) a total light transmittance of 80% or more; (ii) a haze of 5% or less; and (iii) a yellow color index of 3 or less.

According to at least one embodiment, the resin sheet includes at least one layer of an amorphous aromatic polyester resin sheet or a low crystalline aromatic polyester resin sheet.

According to at least one embodiment, there is provided a process for producing an article with a front panel comprising a resinous panel as at least a part thereof, in which the process includes the steps of: producing a resinous panel by using the process according to any one of claims 1 to 5; and assembling an article by using the produced resinous panel.

### BRIEF DESCRIPTION DRAWINGS

FIG. 1 is a conceptual diagram of a cross section of a resinous panel in which cat ears have occurred according to an embodiment.

FIG. 2 is a conceptual diagram of a cross section of a resinous panel that has been processed well through a punching process according to an embodiment.

FIG. 3 is a conceptual diagram of a cross section, showing an example of a preferred Thomson blade according to an embodiment.

### DETAILED DESCRIPTION

According to the various embodiments, the term “sheet” is used as a term that also involves films, plates, etc. The term “resin” is used as a term that also involves resin mixtures including two or more resins, resin compositions including a component other than resin, etc. The term “door body” is used interchangeably or replaceably with “lid body”. The term “front panel” is used interchangeably or replaceably with any of flat panel, back panel, side panel, and bottom panel. The term “Thomson blade” means a blade having a shape known as “Thomson type”. The term “article” means a casing having at least one flat surface on which a resinous panel can be placed, and includes, but is not limited to, refrigerators, washing machines, cupboards and wardrobes, as typical examples. Accordingly, an “outer surface of an article” refers to an outer surface of a casing.

The process according to various embodiments is a process for producing a resinous panel which is for use as at least a part of a front panel of an article, which comprises the step of (A) fixing a resin sheet with a thickness of 0.5-10 mm to a working table.

In the method according to various embodiments, it is generally envisaged that a resin sheet with a uniform thickness is used. Accordingly, the “thickness” of a resin sheet in the present step is usually supposed to be uniform throughout the entire resin sheet. However, it does not aim to limit a front panel of an article as a finished product to have a uniform thickness throughout the entire panel.

According to at least one embodiment, thickness of the resin sheet (when formed with two or more layers, a total of thickness of the layers) is 0.5 mm or more, preferably 0.8 mm or more, even more preferably 1.2 mm or more, from the viewpoint of maintaining a strength and a rigidity necessary as a front panel. On the other hand, the thickness of the resin sheet is 10 mm or less, preferably 7 mm or less, even more preferably 5 mm or less, from the viewpoint of meeting a demand for processability and thinner shapes of articles.

According to at least one embodiment, tensile modulus of elasticity of the resin sheet is preferably 1,500 MPa or more, more preferably 1,800 MPa or more, from the viewpoint of keeping a strength and a rigidity required for a front panel. There is no particular upper limit for the tensile modulus of elasticity, but as long as it is a resin sheet, it is at most about 10,000 MPa in a generally available range. The tensile modulus of elasticity of the resin sheet is measured in conformity with JIS K7127: 1999, under conditions of a test piece type of 1B and a tensile rate of 50 mm/min.

Process of fixing the resin sheet to a working table may be carried out by any process, which is not particularly limited as long as it is a process that can surely carry out the fixing without causing a trouble in the next step (B), and without causing a defect in appearance such as a fixed mark on the resin sheet. Examples thereof may include a process of sandwiching the resin sheet with a jig of which surface is covered with a flexible material such as rubber; a process of pressing the resin sheet by sucking or exhausting using an air; and a process of a combination thereof, etc. Shape of the working table is not particularly limited, as long as it can fix the resin sheet thereto in a certain posture.

The process according to various embodiments includes the step of (B) punching out the front panel by forcing a Thomson blade into the resin sheet approximately perpendicularly thereto from the side where a surface of the resin sheet is to be an outer surface of the article.

Since the process according to various embodiments is a so-called punching process, it has a large degree of freedom in treating various shapes, and is excellent in productivity. In addition, a resin sheet allows even those having a high design property of glass taste to be continuously produced, and easily allows an enhanced productivity. Therefore, it is possible to obtain a resinous panel having a high design property of glass taste in a high productivity, by punching out from a resin sheet.

On the other hand, in a case where the punching process is applied to a thick resin sheet, particularly to a resin sheet having a high tensile modulus of elasticity, even if a Thomson blade is forced into the resin sheet approximately perpendicularly thereto, a defect having a substantially triangular shape with a width of about 100-500 μm often occurs in a cross-sectional view at a cut edge of the surface of the resinous panel from which the Thomson blade was forced, for example, due to a resin that was rolled out by the Thomson blade. Hereinbelow, the defect is referred to as “cat ears”. This means a defect in appearance having a shape of a cat's ear.

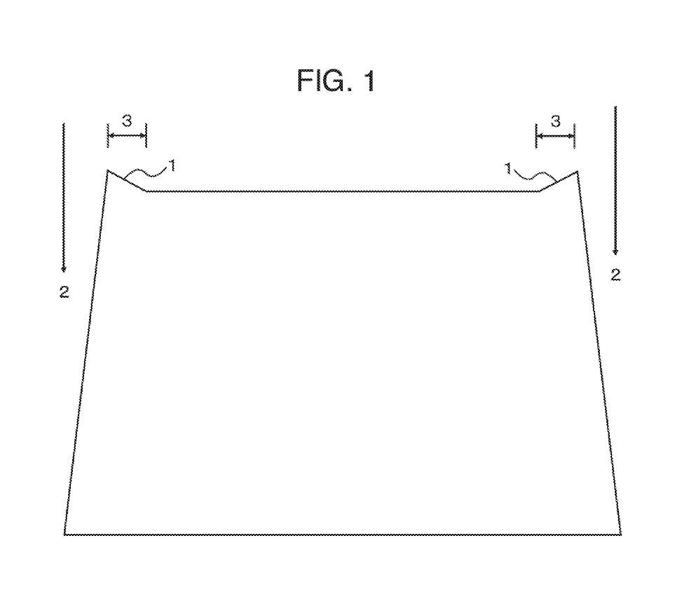

FIG. 1 is a conceptual diagram of a cross section of a resinous panel in which cat ears have occurred according to an embodiment. In FIG. 1, the reference signs “1” show cat ears, the reference signs “2” show the direction in which a Thomson blade is forced, and each of the reference signs “3” shows a width of each of the cat ears.

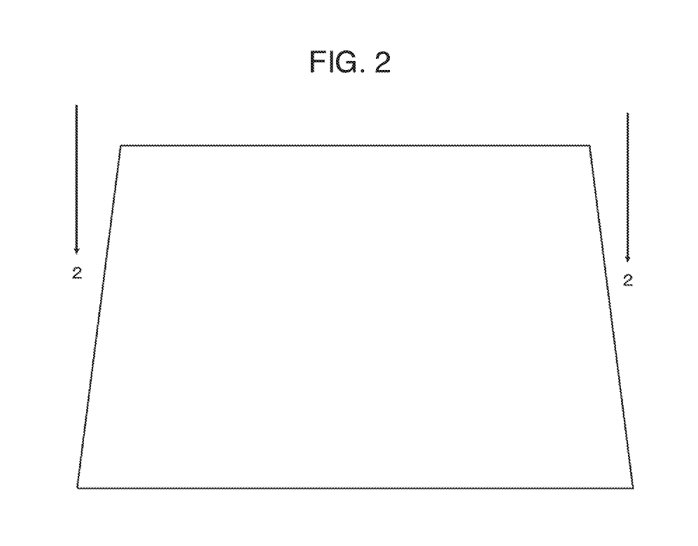

On the contrary, FIG. 2 is a conceptual diagram of a cross section of a resinous panel that has been processed well through a punching process according to an embodiment. In FIG. 2, 2 shows the direction in which a Thomson blade is forced.

In the present invention, the Thomson blade is forced into the resin sheet from the side where a surface of the resin sheet is to be an outer surface of the article. It is specific and surprising that it is possible to solve the problem of cat ears by forcing the Thomson blade from the side where a surface of the resin sheet is to be an outer surface of the article; and by using, as the Thomson blade, one with a double-edged blade having an edge angle of 30-60 degrees.

The process according to various embodiments uses, as the Thomson blade, (C) a double-edged blade having an edge angle of 30-60 degrees, preferably 35-50 degrees. It is possible to solve the problem of cat ears, by using the Thomson blade having such an edge angle. In another embodiment, it is also preferred to use, as the Thomson blade, a double-edged blade having an edge angle of 30-50 degrees, or 35-60 degrees.

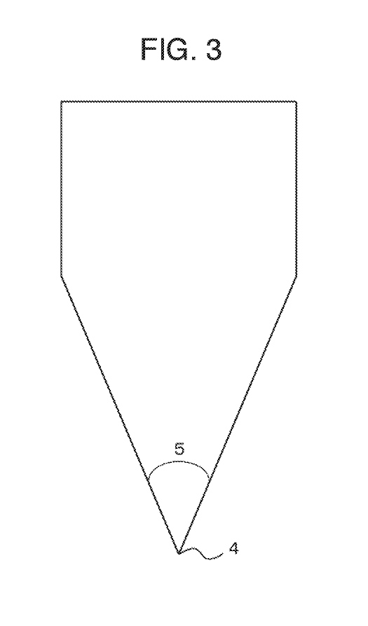

FIG. 3 is a conceptual diagram of a cross section showing an example of a preferred Thomson blade according to an embodiment. In FIG. 3, 4 shows a tip of the blade, and 5 shows an edge angle.

Examples of the double-edged Thomson blade may include single step blades having no angle change from the tip to the end of a blade; two step-blades in which the angle is changed in two steps through the tip to the end of a blade; and three step-blades in which the angle is changed in three steps through the tip to the end of a blade. Among them, the single step blade is preferred, from the viewpoint of preventing the occurrence of cat ears.

Examples of the double-edged Thomson blade may include center blades having a tip in an approximate center in the thickness direction of a blade, and those having a tip leaning to one side in the thickness direction of a blade. Among them, the center blade is preferred from the viewpoint of preventing the occurrence of cat ears.

Thickness of the blade is preferably 0.5-1.5 mm from the viewpoint of preventing the occurrence of cat ears. As another embodiment, it is also preferred that the thickness of the blade is 0.5-1.2 mm, 0.6-1.5 mm, or 0.6-1.2 mm.

Material of the blade is not particularly limited, and a publicly known material may be used as a material that constitutes the blade. Typically, a stainless steel may be used as a material of the blade.

The process according to various embodiments is suitable for production of a resinous panel with a large size, from the viewpoint of ejectability (i.e., workability at the time of removing a punched resinous panel from a Thomson blade), and reduction in defects caused by a joint of a Thomson blade. Size of the resinous panel produced by using the process of the present invention is, although it depends on shape thereof, for example when the shape is approximately rectangular with an aspect ratio of 2:1, preferably equal to or larger than 200 mm in length and 100 mm in width; more preferably equal to or larger than 300 mm in length and 150 mm in width; even more preferably equal to or larger than 400 mm in length and 200 mm in width. When the panel has an approximate circular shape, the size is preferably 100 mm or more in radius, more preferably 150 mm or more in radius, and even more preferably 200 mm or more in radius.

According to at least one embodiment, the resin sheet holds required levels of strength and rigidity for a front panel, and at the same time, preferably comprises a layer of a transparent resin sheet for a function of imparting a glass taste design to a door body. Preferred examples of the resin sheet may include a laminate comprising “a layer of transparent resin sheet—a layer of printed pattern—a layer of colored resin sheet”; a laminate including “a layer of surface protection-a layer of printed pattern—a layer of transparent resin sheet—a layer of colored resin sheet”; and a laminate including “a layer of surface protection-a layer of transparent resin sheet—a layer of printed pattern—a layer of colored resin sheet” in order, from a surface side of the front panel (that is, in order from the side to be an outer surface of the article).

According to at least one embodiment, the transparent resin sheet has a high transparency, from the viewpoint of imparting a glass taste design. The transparent resin sheet is preferably one with a high transparency and not colored.

Therefore, the transparent resin sheet preferably has a total light transmittance (measured in conformity with JIS K7361-1: 1997, using a turbidimeter “NDH2000” (trade name) of Nippon Denshoku Industries Co., Ltd.) of 80% or more, more preferably 85% or more, even more preferably 90% or more. The higher total light transmittance is preferable.

In addition, the transparent resin sheet preferably has a haze (measured in conformity with JIS K7136: 2000, using a turbidity meter “NDH 2000” (trade name) of Nippon Denshoku Industries Co., Ltd.) of 5% or less, more preferably 3% or less, even more preferably 2% or less. The lower haze is preferable.

Furthermore, the transparent resin sheet preferably has a yellow color index (measured in conformity with JIS K7105: 1981, using a colorimeter “SolidSpec-3700” (trade name) of Shimadzu Corporation) of 3 or less, more preferably 2 or less, even more preferably 1 or less. The lower yellow color index is preferable.

According to at least one embodiment, thickness of the transparent resin sheet is not particularly limited, and may be usually 0.1 mm or more, preferably 0.3 mm or more, and more preferably 1 mm or more, from the viewpoint of imparting a deep design. It may also be usually 10 mm or less, preferably less than 10 mm, more preferably 6 mm or less, and even more preferably 3 mm or less, from the viewpoint of meeting a demand for lighter weight of articles.

According to at least one embodiment, the transparent resin sheet may be a single resin sheet, and may also be a laminate of two or more resin sheets. In a case where the transparent resin sheet is a laminate of two or more resin sheets, process for lamination is not limited, and a lamination may be performed by any known process. Examples of the process may include a process of dry laminating or heat laminating resin sheets after obtaining each of the resin sheets by any known process; a process of melting each constituent material in an extruder, and obtaining a laminate by means of T-die co-extrusion by a feed block method, a multi-manifold method, or a stack plate method; an extrusion lamination process which comprising preparing at least one resin sheet by any known process, and then melt-extruding another resin sheet onto the resin sheet; a process in which a melt-extrusion is performed on a certain type of film substrate, or such a film substrate is coated with a coating including a constituent material and a solvent and then dried to form a resin sheet, which is followed by peeling the resin sheet off from the film substrate and transferring the peeled resin sheet onto another resin sheet; and a process of a combination of two or more thereof.

In a case where the transparent resin sheet is a laminate of two or more resin sheets, a printed layer may be provided between any layers in order to enhance a design impression, as required. The printed layer may be formed by printing any pattern by using any type of ink and any type of printer. In order to prevent the printed layer from impairing an impression of depth, it is preferred that the printing be provided partly or provided by using a transparent ink. Number of the printing layer is not limited to one, but may be two or more.

Examples of the transparent resin sheet may include resin sheets of polyester resins such as aromatic polyesters and aliphatic polyesters; acrylic resins; polycarbonate resins; polyolefin resins such as polyethylene, polypropylene and polymethyl pentene; cellulose resins such as cellophane, triacetyl cellulose, diacetyl cellulose and acetyl cellulose butyrate; styrenic resins such as polystyrene, acrylonitrile-butadiene-styrene copolymer resins (ABS resins), styrene-ethylene-propylene-styrene copolymers, styrene-ethylene-ethylene-propylene-styrene copolymers, styrene-ethylene-butadiene-styrene copolymers; polyvinyl chloride resins; poly vinylidene chloride resins; fluorine-containing resins such as polyvinylidene fluoride; and other resin sheets of polyvinyl alcohol, ethylene vinyl alcohol, polyether ether ketone, nylon, polyamide, polyimide, polyurethane, polyether imide, polysulfone, polyether sulfone, etc. These sheets involve unstretched sheets, uniaxially stretched sheets, and biaxially stretched sheets. These sheets also include laminated sheets of two or more layers of one or more types of these.

Among them, an amorphous or a low crystalline aromatic polyester resin sheet is preferred as the transparent resin sheet, from viewpoints of design property, mechanical physical properties required as a panel, and processability.

According to at least one embodiment, the amorphous or low crystalline aromatic polyester resin sheet is a sheet formed from a resin or a resin composition mainly comprising (usually 50% by mass or more, preferably 75% by mass or more, more preferably 90% by mass or more of) an amorphous or a low crystalline aromatic polyester resin.

Examples of the amorphous or low crystalline aromatic polyester resin may include polyester copolymers of: an aromatic polycarboxylic acid component such as terephthalic acid, isophthalic acid, orthophthalic acid and naphthalene dicarboxylic acid; and a polyalcohol component such as ethylene glycol, diethylene glycol, neopentyl glycol, 1,2-butanediol, 1,3-butanediol, 1,4-butanediol, 1,5-pentanediol, 3-methyl-1,5-pentanediol, 2-methyl-1,3-propanediol and 1,4-cyclohexanedimethanol. More specifically, the examples may include one kind or a mixture of two or more kinds of: a glycol-modified polyethylene terephthalate (PETG) comprising 45-50 mol % of terephthalic acid, 30-40 mol % of ethylene glycol, and 10-20 mol % of 1,4-cyclohexanedimethanol; a glycol-modified polycyclohexylenedimethylene terephthalate (PCTG) comprising 45-50 mol % of terephthalic acid, 16-21 mol % of ethylene glycol, and 29-34 mol % of 1,4-cyclohexanedimethanol; an acid-modified polycyclohexylenedimethylene terephthalate (PCTA) comprising 25-49.5 mol % of terephthalic acid, 0.5-25 mol % of isophthalic acid and 45-50 mol % of 1,4-cyclohexanedimethanol; a copolymer comprising 45-50 mol % of terephthalic acid, 5-0 mol % of isophthalic acid, and 25-45 mol % of 1,4-cyclohexanedimethanol and 25-5 mol % of 2,2,4,4,-tetramethyl-1,3-cyclobutanediol; and an acid-modified and glycol-modified polyethylene terephthalates comprising 30-45 mol % of terephthalic acid, 5-20 mol % of isophthalic acid, 35-48 mol % of ethylene glycol, 2-15 mol % of neopentyl glycol, less than 1 mol % of diethylene glycol, less than 1 mol % of bisphenol Al, provided that the total amount of monomers is 100 mol %.

According to at least one embodiment, a DSC measurement is performed by using a Diamond DSC type differential scanning calorimeter of PerkinElmer Japan Co., Ltd., with a temperature program, in which samples were held at 320° C. for 5 minutes, then cooled down to −50° C. at a temperature-decreasing rate of 20° C./min, which were then kept at −50° C. for 5 minutes, and subsequently heated up to 320° C. at a temperature raising rate of 20° C./min to obtain melting curves. Then, a polyester exhibiting a heat of melting of 10 J/g or less in a melting curve obtained from DSC measurement is defined as amorphous one, and a polyester exhibiting a heat of melting of greater than 10 J/g and equal to or less than 60 J/g in a melting curve obtained from DSC measurement is defined as low crystalline one.

According to at least one embodiment, the colored resin sheet serves as a concealing layer for preventing inside of an article (for example, a structure for supporting a front panel, or a heat insulating material filled) from being observed from outside.

According to at least one embodiment, the colored resin sheet is not limited, and any colored resin sheet may be used. Examples thereof may include colored resin sheets of polyester resins such as aromatic polyesters and aliphatic polyesters; acrylic resins; polycarbonate resins, poly(meth)acrylic imide resins; polyolefin resins such as polyethylene, polypropylene and polymethyl pentene; cellulose resins such as cellophane, triacetyl cellulose, diacetyl cellulose, and acetyl cellulose butyrate; styrenic resins such as polystyrene, acrylonitrile-butadiene-styrene copolymer resins (ABS resins), styrene-ethylene-propylene-styrene copolymers, styrene-ethylene-ethylene-propylene-styrene copolymers, styrene-ethylene-butadiene-styrene copolymers; polyvinyl chloride resins; poly vinylidene chloride resins; fluorine-containing resins such as polyvinylidene fluoride; and other colored resin sheets of polyvinyl alcohol, ethylene vinyl alcohol, polyether ether ketone, nylon, polyamide, polyimide, polyurethane, polyether imide, polysulfone, polyether sulfone, etc. These sheets include unstretched sheets, uniaxially stretched sheets, and biaxially stretched sheets. These sheets also include laminated sheets of two or more layers of one or more kinds of these. Here, the lamination may be performed in any known process as described above with reference to the transparent resin sheet.

Among them, sheets of polyvinyl chloride resins and amorphous or low crystalline aromatic polyester resins are preferred as the colored resin sheet, from the viewpoints of design property, mechanical physical properties required as a panel, and processability. The amorphous or low crystalline aromatic polyester resin sheets were as described above in the explanation of the transparent resin sheet.

According to at least one embodiment, the colored resin sheet may include, according to request, an optional component(s) such as a thermoplastic resin such as core-shell rubber; a plasticizer; a pigment, an inorganic filler, an organic filler and a resin filler; and another additive such as a lubricant, an antioxidant, a weathering stabilizer, a heat stabilizer, a release agent, an antistatic agent and a surfactant in a range that is not contrary to the purpose thereof. Examples of the core-shell rubber may include methacrylate-styrene/butadiene rubber graft copolymers, acrylonitrile-styrene/butadiene rubber graft copolymers, acrylonitrile-styrene/ethylene-propylene rubber graft copolymers, acrylonitrile-styrene/acrylate graft copolymers, methacrylate/acrylate rubber graft copolymers, and methacrylate -acrylonitrile/acrylate rubber graft copolymers. Examples of the plasticizer may include, but are not limited to, phthalate plasticizers such as di-2-ethylhexyl phthalate, trimellitate plasticizers, pyromellitate plasticizers, adipate plasticizers, itaconate plasticizers, citrate plasticizers, cyclohexanedicarboxylate plasticizers, and epoxy plasticizers. The blending amount of these optional component(s) may usually be about 0.01-40% by mass with respect to a total mass of the colored resin sheet.

Thickness of the colored resin sheet is not particularly limited, and may be usually 0.03 mm or more, preferably 0.05 mm or more, more preferably 0.1 mm or more, from the viewpoint of obtaining a concealing effect. It is also preferred that the thickness be usually 6 mm or less, preferably 4 mm or less, more preferably 3 mm or less, from the viewpoint of meeting a demand for lighter weight of articles.

It is preferred that the colored resin sheet be one which will not break when subjected to a DuPont impact test in conformity with ASTM-D2794, in an atmosphere of a temperature of 0° C., under conditions of a height of 50 cm, a diameter of an impactor of 1 inch, a weight of an impactor of 1 kg, and a diameter of an impactor receiving support of ½ inch, from the viewpoint of punching processability. It is more preferred that the colored resin sheet be one which will not break when a DuPont impact test is performed in an environment of a temperature of −10° C., under conditions of a height of 50 cm, a diameter of an impactor of 1 inch, a weight of an impactor of 1 kg, and a diameter of an impactor receiving support of ½ inch. The colored resin sheet with the property as described above can prevent a trouble such that a layer of the colored resin sheet is cracked and chipped during a punching process. Furthermore, surprisingly, it also prevents the occurrence of cat ears.

According to at least one embodiment, the layer of printed pattern can be provided to impart a high design property to the resin sheet, and may be formed by printing any pattern using any ink and any printer. The layer of printed pattern may also be formed to double as a concealing layer, instead of the colored resin sheet. In order to impart a metallic taste design, it is also possible to vapor-deposit aluminum, tin, titanium, indium, oxides thereof, or the like on a surface in a front side or a back side of the transparent resin sheet or on a surface in a front side of the colored resin sheet, in whole or in part, directly or via an anchor coat, by a publicly known process.

According to at least one embodiment, the printing may be provided on a surface in a front side or a back side of the transparent resin sheet or on a surface in a front side of the colored resin sheet, in whole or in part, directly or via an anchor coat. Examples of the pattern may include metallic taste patterns such as hair lines, grain patterns, stone mesh patterns imitating surfaces of rocks such as marbles, fabric patterns imitating textures or cloth patterns, tile stitch patterns, brickwork patterns, parquet patterns, and patchwork patterns. As the printing ink, it is possible to use those including a binder to which a pigment, a solvent, a stabilizer, a plasticizer, a catalyst, a curing agent or the like are suitably mixed. As the binder, it is possible to use, for example, polyurethane resins, vinyl chloride-vinyl acetate copolymer resins, vinyl chloride-vinyl acetate-acrylic copolymer resins, chlorinated polypropylene resins, acrylic resins, polyester resins, polyamide resins, butyral resins, polystyrene resins, nitrocellulose resins and cellulose acetate resins, and resin compositions of these resins.

Laminating of the transparent resin sheet and the colored resin sheet is not particularly limited, and may be performed by any known process. Examples of the process may include a heat lamination process and a dry lamination process.

The surface protection layer is not particularly limited, and may be formed, for example, by use of a coating comprising a thermoplastic resin composition such as a polyester resin, an urethane resin, an acrylic resin, a vinyl acetate resin, a vinyl chloride resin, a silicon resin and a fluorine resin; or a coating comprising an active energy ray-curable resin composition such as a composition comprising an active energy ray-curable resin and a compound having two or more isocyanate groups (—N═C═O) in a molecule and/or a photopolymerization initiator, by a publicly known coat-forming process such as roll coating, gravure coating, reverse coating, roll brushing, spray coating, air knife coating and die coating.

According to at least one embodiment, the surface protection layer is not particularly limited, and may be provided, for example, by laminating a coated film formed by using the coating as described above on a surface portion of the resin sheet; a vinylidene fluoride resin film; or a resin film of a biaxially stretched polyethylene terephthalate resin, or the like which is excellent in abrasion resistance or solvent resistance, by a heat lamination process or an adhesive. Thickness of the surface protection layer may be, for example, about 0.05 mm to 1 mm.

### EXAMPLES

Embodiments will be hereinafter described by way of Examples. However, the various embodiments not limited to these Examples.

(P) Transparent Resin Sheet

(P-1) A transparent resin sheet with a thickness of 1,100 μm was formed by a T-die extruding film formation process under a condition of a resin temperature at T-die outlet of 270° C., by using an amorphous aromatic polyester resin “KODAR PETG GS1” (trade name) of Eastman Chemical Company having a glass transition temperature of 81° C. and a heat of melting of 0 J/g (without a clear melting peak in the DSC second melting curve). The tensile modulus of elasticity was 1,500 MPa, the total light transmittance was 89%, the haze was 1.3%, and the yellow color index was 0.4.

(Q) Colored Resin Sheet

(Q-1) A black resin sheet with a thickness of 300 μm was formed from a polyvinyl chloride resin composition comprising 90 parts by mass of a vinyl chloride homopolymer having a degree of polymerization of 800, 10 parts by mass of a core-shell rubber (a methacrylate-styrene/butadiene rubber graft copolymer), and 3 parts by mass of a plasticizer (di-2-ethylhexyl phthalate). When subjected to a DuPont impact test under the conditions as described above, no cracking occurred at any of temperatures of 0° C. and −10° C.

(Q-2) A black resin sheet with a thickness of 150 μm was formed from a polyvinyl chloride resin composition comprising 90 parts by mass of a vinyl chloride homopolymer having a degree of polymerization of 800, 10 parts by mass of a core-shell rubber (a methacrylate-styrene/butadiene rubber graft copolymer), and 3 parts by mass of a plasticizer (di-2-ethylhexyl phthalate). When subjected to a DuPont impact test under the conditions as described above, no cracking occurred at any of temperatures of 0° C. and −10° C.

(Q-3) A black resin sheet with a thickness of 300 μm was formed from a polyvinyl chloride resin composition comprising 95 parts by mass of a vinyl chloride homopolymer having a degree of polymerization of 800, 5 parts by mass of a core-shell rubber (a methacrylate-styrene/butadiene rubber graft copolymer), and 23 parts by mass of a plasticizer (di-2-ethylhexyl phthalate). When subjected to a DuPont impact test under the conditions as described above, no cracking occurred at any of temperatures of 0° C. and −10° C.

(Q-4) A black resin sheet having a thickness of 300 μm was formed from a polyvinyl chloride resin composition comprising 95 parts by mass of a vinyl chloride homopolymer having a degree of polymerization of 800, 5 parts by mass of a core-shell rubber (a methacrylate-styrene/butadiene rubber graft copolymer), and 3 parts by mass of a plasticizer (di-2-ethylhexyl phthalate). When subjected to a DuPont impact test under the conditions as described above, cracking occurred both at temperatures of 0° C. and −10° C.

(R) Adhesive

(R-1) Vinyl chloride-vinyl acetate-acryl copolymer adhesive “VTP-NT” (trade name) of DIC Graphics Corporation

### Example 1

### Production of Front Panel of Article

A multilayer resin sheet was obtained by dry laminating the transparent resin sheet (A-1) and the colored resin sheet (B-1), by using the adhesive (R-1) (the layer of the adhesive (R-1) was formed as a supposed “layer of printed pattern”).

The obtained multilayer resin sheet was cut into an appropriate size and fixed on a working table. A Thomson blade (a double-edged blade of a single step blade type with an edge angle of 42 degrees and a blade thickness of 1 mm) was forced into the multilayer resin sheet approximately perpendicularly thereto from the surface in the side of the transparent resin sheet (i.e., the surface to be an outer surface of an article) to punch out a front panel with a length of 400 mm and a width of 400 mm.

A front panel with a length of 200 mm and a width of 100 mm was punched out in the same manner.

The front panels obtained above were visually observed to check the presence or absence of a defect such as cat ears. Both of the front panels showed a good result (no occurrence of defect was observed).

### Example 2

Production of front panels of article and check of the presence or absence of a defect such as cat ears were performed in the same manner as in the Example 1, except that the colored resin sheet (Q-2) was used as the colored resin sheet. Both of the front panels showed a good result (no occurrence of defect was observed).

### Example 3

Production of front panels of article and check of the presence or absence of a defect such as cat ears were performed in the same manner as in the Example 1, except that the colored resin sheet (Q-3) was used as the colored resin sheet. Both of the front panels showed a good result (no occurrence of defect was observed).

### Example 4

Production of front panels of article and check of the presence or absence of a defect such as cat ears were performed in the same manner as in the Example 1, except that the colored resin sheet (Q-4) was used as the colored resin sheet. In both of the front panels, no cat ears were observed, but cracking and chipping were observed in the colored resin sheet layer.

### Example 5

Production of front panels of article and check of the presence or absence of a defect such as cat ears were performed in the same manner as in the Example 1, except that a double-edged blade of a single step blade type with an edge angle of 26 degrees and a blade thickness of 1 mm was used as the Thomson blade. In both of the front panels, cat ears were observed.

### Example 6

Production of front panels of article and check of the presence or absence of a defect such as cat ears were performed in the same manner as in the Example 1, except that a single-edged blade with an edge angle of 40 degrees and a blade thickness of 1 mm was used as the Thomson blade. In both of the front panels, cat ears were observed.

### Example 7

Production of front panels of article and check of the presence or absence of a defect such as cat ears were performed in the same manner as in the Example 1, except that a double-edged blade of a single step blade type with an edge angle of 30 degrees and a blade thickness of 1 mm was used as the Thomson blade. The front panel of 400 mm in length and 400 mm in width showed a good result (no occurrence of defect was observed). In the front panel of 200 mm in length and 100 mm in width, cat ears were observed.

### Example 8

Production of front panels of article and check of the presence or absence of a defect such as cat ears were performed in the same manner as in the Example 1, except that a double-edged blade of a single step blade type with an edge angle of 36 degrees and a blade thickness of 1 mm was used as the Thomson blade. Both of the front panels showed a good result (no occurrence of defect was observed).

### Example 9

Production of front panels of article and check of the presence or absence of a defect such as cat ears were performed in the same manner as in the Example 1, except that a double-edged blade of a single step blade type with an edge angle of 50 degrees and a blade thickness of 1 mm was used as the Thomson blade. Both of the front panels showed a good result (no occurrence of defect was observed).

### Example 10

Production of front panels of article and check of the presence or absence of a defect such as cat ears were performed in the same manner as in the Example 1, except that the front panels were punched out from a surface in the side of the colored resin sheet (B-1). In both of the front panels, cat ears were observed.

The elements of the process according to the present invention have specifically been described by way of the Examples, however, only for illustrating the present invention. For those having an ordinary knowledge in the field of the various embodiments of the invention, various modifications are available without deviating from the scope of the essential features of the various embodiments. The technical idea or the protection scope sought by the various embodiments is by no means restricted by the Examples disclosed in the present specification. The protection scope sought by the various embodiments should be determined on the basis of recitations of the claims and it is to be construed that any combination of elements in a scope equivalent to the recitations of the claims can be encompassed within the protection scope of the various embodiments.

### REFERENCE SIGNS LIST

1 Cat ears

2 Direction from which Thomson blade is forced

3 Width of each of cat ears

4 Tip of blade

5 Edge angle

1. A process for producing a resinous panel which is for use as at least a part of a front panel of an article, the process comprising the steps of:
(A) fixing a resin sheet with a thickness of 0.5-10 mm to a working table; and
(B) punching out the front panel by forcing a Thomson blade into the resin sheet approximately perpendicularly thereto from a side where a surface of the resin sheet is to be an outer surface of the article,
wherein (C) the Thomson blade is a double-edged blade with an edge angle of 30-60 degrees.

2. The process according to claim 1, wherein the resin sheet preferably has a tensile modulus of elasticity of 1,500 MPa or more.

3. The process according to claim 1, wherein the resin sheet comprises a layer of a transparent resin sheet and a layer of a colored resin sheet in this order from the side to be an outer surface of an article; and the colored resin sheet is one which does not break when subjected to a DuPont impact test in conformity with ASTM-D2794, in an atmosphere of a temperature of 0° C., under a condition of a height of 50 cm, a diameter of an impactor of 1 inch, a weight of an impactor of 1 kg, and a diameter of an impactor receiving support of ½ inch.

4. The process according to claim 3, wherein the resin sheet meets the following properties (i)-(iii):
(i) a total light transmittance of 80% or more;
(ii) a haze of 5% or less; and
(iii) a yellow color index of 3 or less.

5. The process according to claim 1, wherein the resin sheet comprises at least one layer of an amorphous aromatic polyester resin sheet or a low crystalline aromatic polyester resin sheet.

6. A process for producing an article with a front panel comprising a resinous panel as at least a part thereof, the process comprising the steps of:
producing a resinous panel by using the process according to claim 1; and
assembling an article by using the resinous panel obtained from the production step.

7. The process according to claim 2, wherein the resin sheet comprises a layer of a transparent resin sheet and a layer of a colored resin sheet in this order from the side to be an outer surface of an article; and the colored resin sheet is one which does not break when subjected to a DuPont impact test in conformity with ASTM-D2794, in an atmosphere of a temperature of 0° C., under a condition of a height of 50 cm, a diameter of an impactor of 1 inch, a weight of an impactor of 1 kg, and a diameter of an impactor receiving support of ½ inch.

8. The process according to claim 7, wherein the resin sheet meets the following properties (i)-(iii):
(i) a total light transmittance of 80% or more;
(ii) a haze of 5% or less; and
(iii) a yellow color index of 3 or less.
